(19) United States
(12) Patent Application Publication
(10) Pub. No.: US 2021/0257778 A1
(43) Pub. Date: Aug. 19, 2021

(54) ANGLED CONNECTOR WITH A MODULE SLIDING ALONG A CURVED PATH

(71) Applicant: Aptiv Technologies Limited, St. Michael (BB)

(72) Inventors: Jean Fabre, Chartres (FR); Frédéric Belliard, TREMBLAY LES VILLAGES (FR); Stéphane Lacote, CHARTRES (FR)

(21) Appl. No.: 17/114,878

(22) Filed: Dec. 8, 2020

(30) Foreign Application Priority Data
Feb. 14, 2020 (EP) EP 20157319.3

(51) Int. Cl. H01R 13/629; H01R 13/502; H01R 13/52; H01R 13/639

(52) U.S. Cl. CPC H01R 13/629; H01R 13/502; H01R 2201/26; H01R 13/639; H01R 13/5205

(57) ABSTRACT

A connector including a housing and a terminal holding module. The terminal holding module has cavities for accommodating terminals. The terminals have a mating portion extending in a longitudinal direction. The terminal holding module is slidably mounted in the housing. The housing has a rear portion extending in a first direction for inserting the terminal holding module in the housing while the longitudinal direction is parallel to the first direction. The housing further comprises a front portion extending in a second direction for accommodating the terminal holding module in the housing in an operation position, while the longitudinal direction is parallel to the second direction which is different from the first direction.

### CROSS-REFERENCE TO RELATED APPLICATION

This application claims benefit of priority to European Patent Application No. 20157319.3 filed in the European Patent Office on Feb. 14, 2020, the entire disclosure of which is hereby incorporated by reference.

### TECHNICAL FIELD OF THE INVENTION

This disclosure generally relates to the field of automotive connections. More particularly this disclosure relates to non-straight or angled connectors, e.g. right-angle connectors. In this disclosure, power connectors are presented as an example, but the person skilled in the art will easily understand how to apply this disclosure to any kind of angled connectors.

### BACKGROUND

In the connector field, at least two types of connectors are commonly used: straight connectors and angled connectors, such as right-angle connectors.

It is easily understood that the assembly of angled connectors may be more complex than the assembly of straight connectors, particularly when angled terminals are used. Indeed, terminals must be accommodated in individual cavities insulated from one another by dielectric material. Further, the connection of the wires to the terminals, for example by crimping, can be carried out by wire harness manufacturers while the final assembly of the connector can be carried out by another supplier or manufacturer. It then becomes difficult to insert the terminals in the connector housing. Consequently, the assembly processes can be complex and costly.

### BRIEF SUMMARY

Indeed, the use of a terminal holding module allows wires to be connected to terminals prior to the insertion of the terminals in the terminal holding module, and prior to the mounting of the terminal holding module in the housing. Consequently, the terminal holding module can be prepared with (typically) basic standard straight terminals and wires by a wire harness manufacturer, while the final mounting of the terminal holding module in the housing can be made by another manufacturer.

According to one or more aspects of the present disclosure, a connector includes a terminal holding module. The terminal holding module includes at least one cavity for accommodating at least one straight terminal having a mating portion extending in a longitudinal direction. The terminal holding module is mounted in the housing. The housing has a cavity with a rear portion extending in a first direction for inserting the terminal holding module in the housing while the longitudinal direction is parallel to the first direction and a front portion extending in a second direction for accommodating the terminal holding module in the housing in an operation position while the longitudinal direction is parallel to the second direction. The second direction is different from the first direction. The terminal holding module is movable from the rear portion towards its operation position in the front portion.

In one or more embodiments of the connector according to the previous paragraph, the first direction is orthogonal to the second direction.

In one or more embodiments of the connector according to any one of the previous paragraphs, the housing comprises guiding features for guiding the terminal holding module in the housing towards its operation position. The guiding features have a generally curved shape.

In one or more embodiments of the connector according to any one of the previous paragraphs, the terminal holding module has a protrusion for wedging the terminal holding module in the housing while in its operation position.

In one or more embodiments of the connector according to any one of the previous paragraphs, the terminal holding module comprises at least a first part and a second part, the first part being rotatable relative to the second part.

In one or more embodiments of the connector according to any one of the previous paragraphs, the first part comprises at least one straight cavity for accommodating the at least one straight terminal.

In one or more embodiments of the connector according to any one of the previous paragraphs, the second part comprises at least one cavity with a single wire seal therein.

In one or more embodiments of the connector according to any one of the previous paragraphs, the second part comprises means for locking the terminal holding module in the housing in its operation position.

In one or more embodiments of the connector according to any one of the previous paragraphs, the first and second parts comprise means for maintaining alignment of the first part and the second part while the terminal holding module is inserted in the housing.

In one or more embodiments of the connector according to any one of the previous paragraphs, the housing comprises guiding features for guiding the terminal holding module in the housing towards its operation position, wherein the guiding features have a generally curved shape, wherein the guiding features comprise an insertion portion, and wherein the second part is maintained in the first direction and a step for tilting the first part relative to the second part while the first part and the second part are released from the means for maintaining alignment.

In one or more embodiments of the connector according to any one of the previous paragraphs, the housing comprises at least two cavities and wherein each of the at least two cavities accommodate one high-power terminal.

### BRIEF DESCRIPTION OF THE DRAWINGS

The present invention will now be described, by way of example with reference to the accompanying drawings, in which:

FIG. 1 is a schematic perspective view of a right-angle connector in accordance with an embodiment;

FIG. 2 is a schematic perspective view of an inner housing to be mounted in a right-angle connector such as the one illustrated by FIG. 1 in accordance with an embodiment;

FIG. 3 is a schematic lateral view of a terminal holding module to be mounted in an inner housing such as the one illustrated by FIG. 2 in accordance with an embodiment;

FIG. 4 is a schematic perspective view of a first part of the terminal holding module illustrated by FIG. 3 in accordance with an embodiment;

FIG. 5 is a schematic perspective view of a second part of the terminal holding module illustrated by FIG. 3 in accordance with an embodiment;

FIGS. 6A through FIG. 6D illustrate the mounting of the terminal holding module of FIG. 3 in the inner housing of FIG. 2 in accordance with an embodiment; and

FIG. 7 a schematic perspective view illustrating the locking means of the terminal holding module of FIG. 3 in the inner housing of FIG. 2 in accordance with an embodiment.

### DETAILED DESCRIPTION

An example of connector 1 is shown in FIG. 1. This connector 1 is a right-angled connector for connecting power cables 2 to a socket connector 3. As it is known in the power connectivity field, the current supply in the power cables 2 can be controlled by an HVIL line (“HVIL” standing for High Voltage Interlock Line) comprising HVIL terminals 4 (shown in FIGS. 6A to 6D), for safety reasons. Hence, this connector 1 comprises two power terminals (not shown), each respectively connected to a power cable 2, and two HVIL terminals 4 connected to the HVIL line.

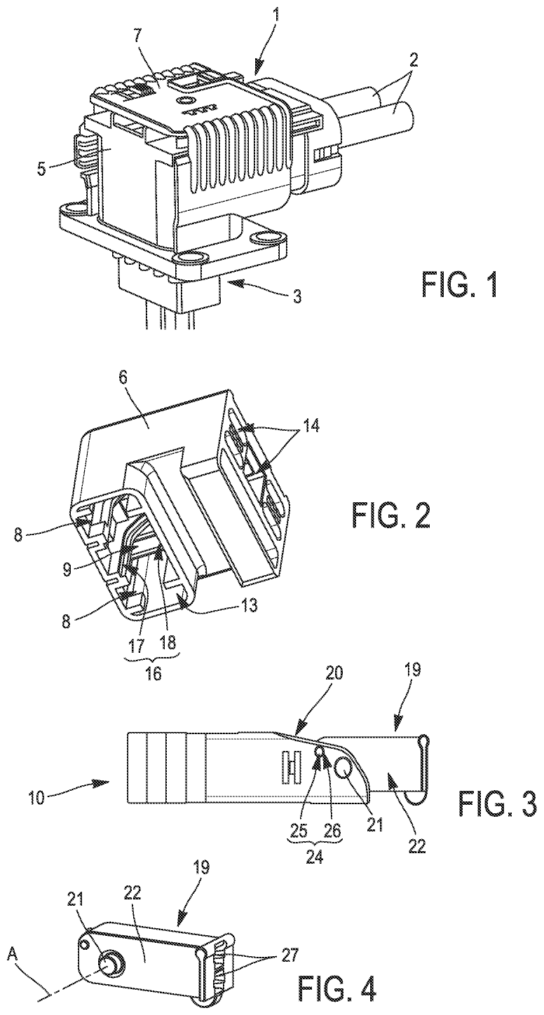

The connector 1 further comprises an outer housing 5 and an inner housing 6 (FIG. 2), as well as electromagnetic shields and a mating assist mechanism 7. The general architecture of such a connector 1 is described for example in the patent document U.S. Pat. No. 9,059,540B2 which is hereby incorporated by reference.

The inner housing 6 of the connector 1 is made of a dielectric material. For example, the inner housing 6 is made of moulded plastic. The inner housing 6 has two lateral cavities 8 for accommodating power terminals and a central cavity 9 for accommodating a terminal holding module 10 (See FIG. 3). More precisely, the terminal holding module 10 houses HVIL terminals 4 (See FIGS. 6A to 6D).

The inner housing 6 has a general right-angled shape. The central cavity 9 has a rear portion 11 (See FIGS. 6A to 6D) extending in a first direction D and a front portion 12 extending in a second direction E which is orthogonal to the first direction D. The rear portion 11 has a rear opening 13 which is widely open. The front portion 12 has several front openings 14, one of which is configured to receive a counterpart connector comprised in the socket connector 3, to be mated with the HVIL terminals 4 accommodated in the terminal holding module 10.

The rear portion 11 is a straight portion extending in the first direction D, the front portion 12 is a straight portion extending in the second direction E and there is a curved portion 15 between the rear portion 11 and the front portion 12. The central cavity 9 is thus configured to allow the terminal holding module 10 to be guided through the rear portion 11, the curved portion 15 and then finally the front portion 12 where it assumes its operation position.

The inner housing 6 comprises guiding features 16 for guiding the terminal holding module 10 in the inner housing 6 from the rear opening 13 where it is first inserted, towards its operation position. The guiding features 16 have a generally curved shape. More particularly, the guiding features 16 have straight paths each corresponding respectively to the rear portion 11 and the front portion 12, as well as a curved path in between. These paths are defined by two upper rails 17 and a lower floor 18.

As shown on FIGS. 3 to 5, the terminal holding module 10 comprises a first part 19 and a second part 20. The first part 19 has two pins 21 protruding on respective opposite lateral faces 22 and engaging in two corresponding openings 23 of the second part 20. The two pins 21 extend parallel to a rotation axis A. The first part 19 is rotatable about this rotation axis A relative to the second part 20.

The terminal holding module 10 also comprises temporary blocking means 24. For example, this temporary blocking means 24 comprises two bumps 25 on the first part 19, and two holes 26 in the second part 20. The two bumps 25 protrude on respective opposite lateral faces 22 and engage in a corresponding hole 26 of the second part 20. The temporary blocking means 24 maintains aligned the first part 19 and the second part 20 while the terminal holding module 10 is inserted in the inner housing 6 (See FIG. 6A). During the sliding of the terminal holding module 10 in the inner housing 6 along the curved path, the two bumps 25 are forced out of the two holes 26 and the first part 19 and the second part 20 can rotate relative to each other about the rotation axis A. More precisely, the guiding features 16 comprises a step 36 for tilting the first part 19 relative to the second part 20 (See FIG. 6B), forcing the first part 19 and the second part 20 to be released from the temporary blocking means 24.

The first part 19 comprises two cavities 27 for accommodating each respectively an HVIL terminal 4 (basically a straight terminal). Each HVIL terminal 4 is electrically connected, for example by crimping, to an HVIL electrical wire 28. An HVIL terminal 4 extends in a straight direction in each one of the cavities 27. The HVIL electrical wires 28 extend out of the first part 19, in the second part 20. The HVIL electrical wires 28 remain flexible and free to move in the inner housing 6 between the first part 19 and the second part 20 so as to accompany the rotation of the first part 19 relative to the second part 20 (See FIG. 6B to FIG. 6D).

The first part 19 has a protrusion 29 extending toward the lower floor 18. This protrusion 29 helps wedge the terminal holding module 10 in the inner housing 6, when the terminal holding module 10 is in its final operation position. Indeed, for rotating the first part 19 in the curved portion, the first part 19 cannot be as large as the curved portion. However, in its operation position, the terminal holding module 10 should be tightly maintained in the inner module 6. Then the protrusion 29 wedges the terminal holding module 10 in its front region and the second part 20 pushes the rear region of the terminal holding module 10.

The second part 20 comprises two cavities 30 through which the HVIL electrical wires 28 are guided. A single wire seal (SWS) is placed in each one of these two cavities 30, for providing a sealing between each HVIL electrical wire 28 and the second part 20. An additive flat seal (not shown) covering both the terminal holding module 10 and the inner housing 6 can complete the sealing.

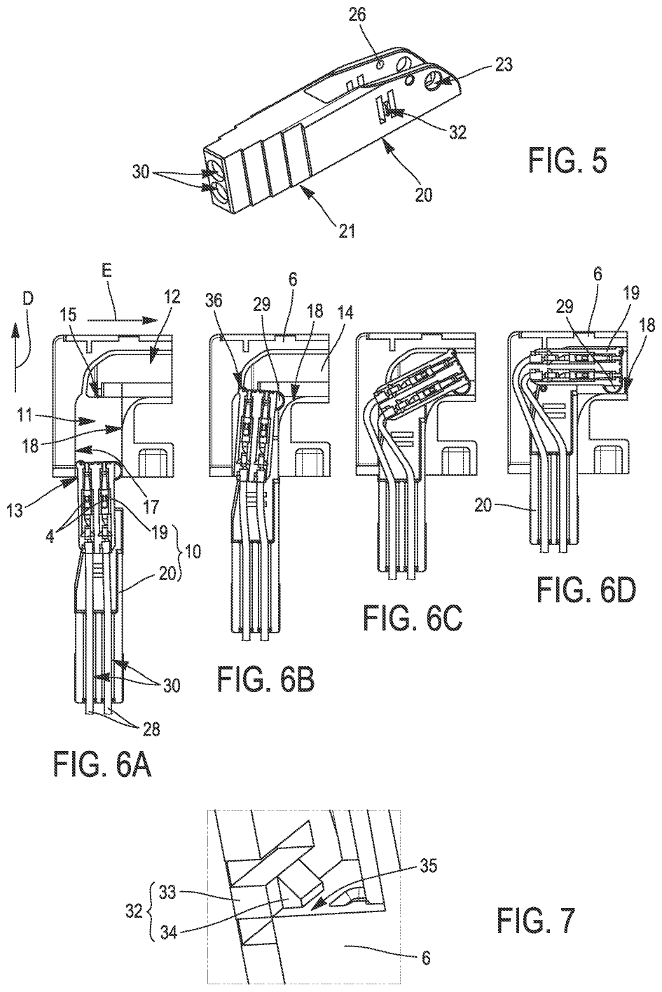

The second part 20 also comprises a prehension area 31 (See FIG. 5) through which an operator can handle and push the terminal holding module 10 in the inner housing 6.

The second part 20 comprises locking means 32 for locking the terminal holding module 10 in the inner housing 6, in its operation position. This locking means 32 comprises two beams 33 extending in an opening in respective opposite lateral faces of the second part 20 to provide some flexibility to the two beams 33 (See FIG. 7). A tooth 34 is provided on each of the two beams 33. Each tooth 34 protrudes from the lateral faces of the second part 20. When the terminal holding module 10 is in its operation position, each tooth 34 engages behind a stop 35 made on the inner housing 6 to lock the terminal holding module 10 in the inner housing 6.

The connector assembly process comprises for example the following steps:
The HVIL terminals 4 are crimped on HVIL electrical wire ends (previously passed through their respective cavity 30 in the second part 20 of the terminal holding module 10, together with a single wire seal);
The HVIL terminals 4 are inserted in their respective cavity 27 in the first part 19 of the terminal holding module 10, where they are held with locking lances of a well-known type;
Possibly at another manufacturer, the terminal holding module 10 is inserted through the rear opening 13 of the inner housing 6 and locked in the inner housing 6, in its operation position thanks to the locking means 32; and
The inner housing 6 is mounted in an outer housing 5, with power terminals, electromagnetic shields, sealing means, mating assist device 7, etc.

1. A connector, comprising:
a housing; and
a terminal holding module, wherein the terminal holding module includes at least one cavity for accommodating at least one straight terminal having a mating portion extending in a longitudinal direction, wherein the terminal holding module is mounted in the housing, wherein the housing has a cavity with a rear portion extending in a first direction for inserting the terminal holding module in the housing while the longitudinal direction is parallel to the first direction and a front portion extending in a second direction for accommodating the terminal holding module in the housing in an operation position while the longitudinal direction is parallel to the second direction, wherein the second direction is different from the first direction, and wherein the terminal holding module is movable from the rear portion towards its operation position in the front portion.

2. The connector according to claim 1, wherein the first direction is orthogonal to the second direction.

3. The connector according to claim 1, wherein the housing comprises guiding features for guiding the terminal holding module in the housing towards its operation position, wherein the guiding features have a generally curved shape.

4. The connector according to claim 1, wherein the terminal holding module has a protrusion for wedging the terminal holding module in the housing while in its operation position.

5. The connector according to claim 1, wherein the terminal holding module comprises at least a first part and a second part, the first part being rotatable relative to the second part.

6. The connector according to claim 5, wherein the first part comprises at least one straight cavity for accommodating the at least one straight terminal.

7. The connector according to claim 5, wherein the second part comprises at least one cavity with a single wire seal therein.

8. The connector according to claim 5, wherein the second part comprises means for locking the terminal holding module in the housing in its operation position.

9. The connector according to claim 5, wherein the first and second parts comprise means for maintaining alignment of the first part and the second part while the terminal holding module is inserted in the housing.

10. The connector according to claim 9, wherein the housing comprises guiding features for guiding the terminal holding module in the housing towards its operation position, wherein the guiding features have a generally curved shape, wherein the guiding features comprise an insertion portion, and wherein the second part is maintained in the first direction and a step for tilting the first part relative to the second part while the first part and the second part are released from the means for maintaining alignment.

11. The connector according to claim 1, wherein the housing comprises at least two cavities and wherein each of the at least two cavities accommodate one high-power terminal.
